(19) United States
(12) Patent Application Publication
(10) Pub. No.: US 2008/0152305 A1
(43) Pub. Date: Jun. 26, 2008

(54) Portable Media Content Storage and Rendering Device

(75) Inventor: Terry L. Ziegler, Lansdale, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/614,335

(22) Filed: Dec. 21, 2006

(51) Int. Cl. H04N 5/91; H04N 7/173

(52) U.S. Cl. 386/94; 725/110; 725/87

(57) ABSTRACT

A portable media content storage and rendering device is disclosed which organizes, enables portability, and manages purchased media content, or media content from a digital video recorder (“DVR”). In an illustrative example, the DVR is integrated a set-top box (“STB”). The STB also functions as a proxy device to facilitate selecting and receiving the purchased media over a distribution network. The purchased media content and/or DVR media content is copied to the portable media storage and rendering device from the STB as a digital television stream which is facilitated by a user interface application that is hosted by the STB. The copied media content is used in accordance with a digital rights management license from a media content service. The portable media storage and rendering device has an onboard video processor which is arranged to support different external presentation devices such as televisions and monitors using a variety of resolutions and formats.

### BACKGROUND

Media content, including music and video (such as television and movies), has historically been distributed using a variety of different physical containers and encoding formats that have changed over time: vinyl LP, 8-track cartridge, audio cassette, Betamax video cassette, VHS video cassette, compact disc (“CD”) and digital versatile disc (“DVD”). The current CD and DVD formats are anticipated to eventually be replaced by new formats. New music formats include Super Audio CD (“SACD”) and DVD-Audio. SACD uses a 1-bit system called Direct Stream Digital which employs a substantially higher sampling rate than conventional CDs. DVD-Audio lets recording engineers select any of several sampling rates and word sizes using a lossless compression technique called Meridian Lossless Packing. Both new audio formats provide an upper frequency limit that is more than twice that of current PCM (Pulse Code Modulated) encoded CD with a substantial improvement in dynamic range. New DVD formats for video type media content include Sony's Blu-ray disc and the HD-DVD developed by a group of consumer electronics and computer companies led by Toshiba. Both new DVD formats provide greater capacity that is designed to store high-definition video that has approximately four times the resolution of standard-definition video.

Media content formats are typically incompatible with each other. For example, a Blu-ray high-definition disc is not playable in an HD-DVD player (and vice-versa), nor is an SACD disc playable on a DVD-Audio player. In addition, there is only limited backwards compatibility. While SACD has an optional provision for a standard-CD-compatible layer, not all discs include such features. And while DVD-Audio discs are designed to be playable on current DVD players, they are not playable on current CD players.

The result of changing formats and incompatibility among physical container formats is that consumers can face a situation in which their media content becomes obsolete or unusable as a result of container damage or wear. Consumers have demonstrated some reluctance to repurchase media content merely due to format change or when the benefits provided by the new format are perceived as being incremental. In addition, consumers face frustration when media content becomes unusable due to failure of the physical container. One result is that consumers are increasingly relying on downloads from online sources to purchase media content. Downloaded file formats include, for example, MP3 (Moving Pictures Expert Group, MPEG-1, audio layer 3), WMA (Windows Media Audio) and MPEG-4 AAC (Advanced Audio Coding) for audio media content. WMV (Windows Media Video), MPEG-2, MPEG-4 (also known as International Telecommunications Union ITU-T H.264), and RealMedia are popular formats for video.

Although downloaded digital media content files have some susceptibility to evolving and changing formats, they are not locked to a particular physical data container which can improve resistance to obsolescence. However, the digital rights management (“DRM”) license schemes that often accompany downloaded media content files generally impose restrictions which lock the media content to a particular number of playback devices such as a computer or portable media player. For example Apple Computer's popular iTunes service limits playback of downloaded media content to five computers. Consumer are thus locked to certain playback devices which can often be limited, in the case of video playback, in terms of rendering capability such as image size and resolution. While larger monitors are available, many users have computer monitors that are sized 20 inches or smaller which are very modest by television standards for watching video such as movies. And, portable media players typically have very small displays that are only suited for personal use and which are not generally perceived as substitutes for traditionally sized presentation devices. Downloaded content is also frequently limited to resolutions that are lower than that utilized with regular cable or broadcast television.

### DESCRIPTION OF THE DRAWINGS

FIG. 1 is a diagram of an illustrative media distribution architecture including a media content server, several databases, a distribution network, a set-top box (“STB”), and a portable media content storage and rendering device;

FIG. 2 is a diagram showing an illustrative conditional access system and portions of the media distribution architecture shown in FIG. 1;

FIG. 3 is a pictorial view of the STB and portable media content storage and rendering device as operatively coupled along with several illustrative graphical user interface (“GUI”) screen shots;

FIG. 4 is a pictorial view of the portable media content storage and rendering device as operatively coupled to a presentation device along with a view of the portable media content storage and rendering device's back panel showing various illustrative output connections;

FIG. 5 shows the portable media content storage and rendering device depicted in FIG. 1 as connected to a presentation device along with an illustrative GUI screen shot displayed thereon;

FIG. 6 is a pictorial view of an illustrative alternative small form factor portable media content storage and rendering device as operatively coupled to an STB;

FIG. 7 shows the portable media content storage and rendering device depicted in FIG. 6 as connected to a presentation device along with an illustrative GUI screen shot displayed thereon;

FIG. 8 is a diagram of an illustrative device and accessory connector arrangement used to connect a portable media content storage and rendering device to an STB;

FIG. 9 shows front views of the connectors shown in FIG. 7;

FIG. 10 shows a cutaway view of an accessory connector disposed within the body of the small form factor portable media content storage and rendering device;

FIG. 11 is a pictorial representation of an illustrative STB having a portable media content storage and rendering device receiving bay with an opening in the front;

FIG. 12 is a pictorial representation of an illustrative STB having a portable media content storage and rendering device receiving bay with an opening in the front with a portable media content storage and rendering device inserted therethrough;

FIG. 13 shows an enlarged interior perspective view of an illustrative portable media content storage and rendering device receiving bay;

FIG. 14 shows an enlarged interior perspective view of an illustrative portable media content storage and rendering device receiving bay showing the connectors in an operative relationship before being mateably engaged;

FIG. 15 shows an enlarged interior perspective view of an illustrative portable media content storage and rendering device receiving bay showing the connectors in an operative relationship after being mateably engaged;

FIG. 16 is a simplified functional block diagram of the illustrative STB shown in FIG. 1;

FIG. 17 is a simplified functional block diagram of the illustrative portable media content storage and rendering devices shown in FIGS. 1 and 6; and

FIG. 18 is a flowchart of an illustrative method for providing a media content distribution service.

### DETAILED DESCRIPTION

A portable media storage and rendering device is disclosed which organizes, enables portability, and manages purchased media content, or media content copied from a digital video recorder (“DVR”). In an illustrative example, the DVR is integrated in a terminal such as a set-top box (“STB”). The STB also functions as an intermediary, or “proxy” device, to facilitate selecting and receiving the purchased media over a distribution network such as a broadband cable system. The purchased media content and/or DVR media content is then copied to the portable media content storage and rendering device from the STB as a digital television (“DTV”) stream which is facilitated by a user interface application that is hosted by the STB.

The copied media content is typically subject to digital rights management (“DRM”) license limitations or provided using a conditional access system. Such arrangements ensure that only devices authorized by the media content service can store and render the media content. By receiving media content from the online media content service (via the STB), the portable media content storage and rendering device is freed from the limitations imposed by a physical data container where format changes can cause problems with media content obsolescence. Thus, the portable media storage and rendering device can be populated with the latest versions of media content in the formats that are optimized for the presentation devices, such as televisions and monitors, that are being used.

The portable media storage and rendering device is generally arranged to be conveniently moved from place to place and then coupled to an external presentation device to render the stored media content. The portable media storage and rendering device has an onboard video processor that is arranged to support different external presentation devices employing a variety of resolutions and formats. Accordingly, the portable media storage and rendering device is presentation device-independent and is not locked to a particular display size, format, or resolution.

The combination of physical data container-independence and presentation device-independence advantageously gives the portable media storage and rendering device the ability to supply media content conveniently and flexibly in a wide variety of settings. In particular, the device enables a user to take full resolution versions of their owned or recorded media content with them anywhere and without the limitations on display quality or size as may be experienced with other arrangements.

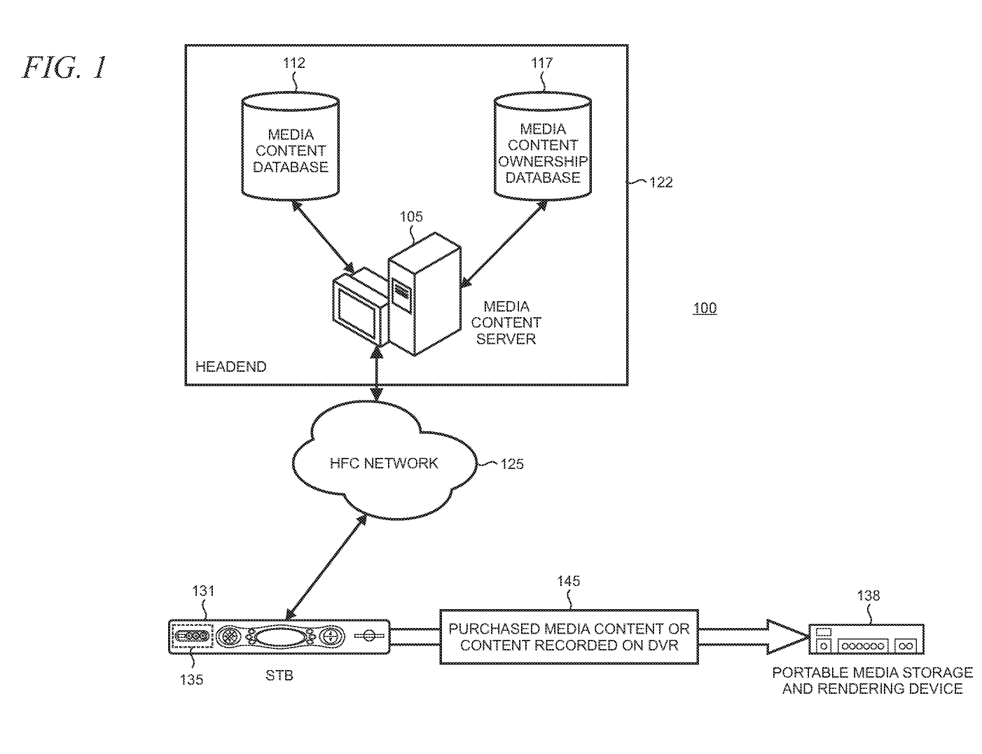

Turning now to the drawings where like reference numerals indicate like elements, FIG. 1 is a diagram of an illustrative media distribution architecture 100 including a media content server 105, a media content database 112, a media content ownership database 117, a distribution network 125, an STB 131, and a portable media content storage and rendering device 138. It is noted that a variety of media types are storable in portable media content storage and rendering device 138, including but not limited to audio, pictures, data, software, games, ring tones, music, and combinations thereof.

Distribution network 125 in this illustrative example is a hybrid fiber-coax (“HFC”) network in which optical fiber cable and coaxial cable are used in different portions of a network to carry broadband content including media content. HFC networks are commonly used to distribute cable television and broadband data services to terminal devices located in homes and businesses. Data and media content provided by such services are typically encrypted and encoded, as described below, and then decrypted and decoded by authorized terminal devices. In alternative arrangements, other network types are usable, for example, fiber-to-the-home (“FTTH”) networks that are IP-based (Internet Protocol).

The media content server 105 is coupled to the distribution network 125. Media content server 105 is typically disposed at the headend of an HFC network. Media content server 105 is arranged to serve media content to the STB 131 over the distribution network 125. The media content served by the media content server 105 is stored in a coupled media content database 112. A media content ownership database 117 is also coupled to the media content server 105. Media content ownership database 117 is an example of a business system database that is used to associate and track orders, subscriptions, and other data from a consumer with the media content stored on media content database 112. In this illustrative example, media content server 105, media content database 112, and media content ownership database 117 are disposed at a common headend 122. In alternative arrangements, databases 112 and 117 may be remotely located from media content server 105 and accessed via a connection selected from one of network link, satellite link, or fiber-optic link (not shown). The structures shown in headend 122 along with distribution network 125 are typically employed by a service provider or operator such as an MSO (multiple system operator) that has cable entertainment systems in multiple locations.

STB 131 is one example of a terminal device among a plurality of other such devices (not shown) on distribution network 125 that is arranged to receive media content typically by tuning to selected media content contained in a broadband signal sent from media content server 105. For example, a cable television/broadband service consumer typically purchases a subscription that entitles the subscriber to select and consume programming from a set variety of channels. The selected media content can then be rendered (i.e., decrypted and decoded as required) onto a coupled presentation device such as a television or monitor. Such selected media content is also recordable to an internally disposed DVR in STB 135 (shown in phantom view in FIG. 1).

In addition to media content that is selectively tuned from the broadband signal from media content server 131 and then rendered or recorded, STB 131 is arranged in this illustrative example so that the consumer may select and receive specially ordered programming that typically falls outside programming choices provided by the channels in the subscription. Such specially ordered programming includes video-on-demand (“VOD”) and Pay-per-View (“PPV”) programming. Both VOD and PPV programming may require a separate purchase by the consumer to receive and consume the selections where the purchase price is normally added to the regular subscription cost. In some applications, a separate VOD and/or PPV content server is used. However, in the present illustrative example media server 131 is arranged to serve both regular subscription and specially ordered (e.g., VOD and PPV) programming to STB 131.

STB 131 is additionally configured to serve as a proxy device for a user to browse, select, and then make an outright purchase of media content that is downloaded to the STB 131 (and which may be copied to the portable media content storage and rendering device 138). Such outright purchased media content is typically arranged in a similar manner as traditionally purchased media content (i.e., that provided on a physical container such as CD or DVD) so that a user may consume the media content on an unlimited time basis over an indefinite time period. However, in some cases, such outright purchased media content may be subject to some usage limitations according to an associated DRM license.

The portable media content storage and rendering device 138 is operatively coupled to STB 131 to receive selected media content, as shown in FIG. 1. The received media content is selectable from media content recorded on the STB's internal DVR. In addition, the received media content may be selected and ordered (typically on a purchased basis per media content item as described above, or on PPV or VOD basis) from media content stored on media content database 112. The media content sent from media server 131 and received by portable media content storage and rendering device 138 is indicated by reference numeral 145.

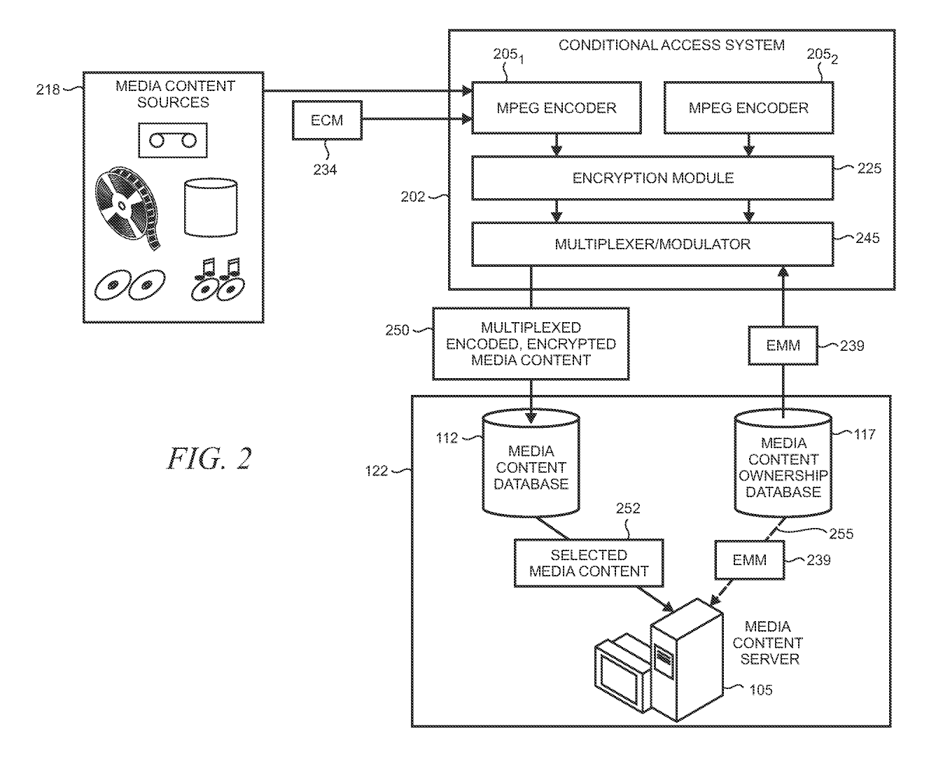

FIG. 2 is a diagram showing an illustrative conditional access system 202 that is operatively coupled to the media content database 112 and media content ownership database 117. Suitable conditional access systems include, for example, DigiCipher, DigiCipher 11, or MediaCipher. The conditional access system 202 functions to ensure that only authorized terminals on the distribution network 125 (FIG. 1) are capable of receiving and using particular media content. The conditional access system 202 includes several MPEG encoders 205, and 2052. Although two MPEG encoders are shown in FIG. 2, the number of encoders used can vary according to the specific requirements of an application of the present portable storage device. The output of the MPEG encoders 205 are coupled to an encryption module 225.

Media content sources 218 are coupled to the input of MPEG-2 encoder 2051. Other media content sources (not shown) are also normally coupled to the other MPEG-2 encoders 205 used in the conditional access system 202. Media content sources 218 illustratively provide a variety of different media types including film, magnetic videotape, disc, data from a database, and music.

Referring now to an illustrative example where the media content from the media content sources 218 comprises video (e.g., television or movie content), the video is encoded by the MPEG encoder 205, into a format that is compliant with MPEG-2. Other formats are also alternatively usable including, for example, MPEG-4/H.264. Other encoder types may also be used in some applications including RealVideo and Windows Media/VC-1.

The MPEG encoded video stream is received by the encryption module 225 which encrypts the video so that only authorized terminals (i.e., those registered with the service provider) will be able to receive and decrypt the video. Encryption module 225 also encodes an Entitlement Control Message 234 (“ECM”) to provide properly authorized terminals with the keys necessary to decrypt the encrypted video. ECM 234 provides conditional access information including, for example, control and/or encryption parameters that are typically associated with a specific video by being embedded in the overhead of the video's MPEG-2 stream.

The encrypted output streams from the MPEG encoders 205 are received by multiplexer/modulator 245 which multiplexes the streams into a multiplexed signal 250 typically containing a plurality of encoded and encrypted media content streams. Multiplexer/modulator 245 may also be optionally arranged to perform modulation, for example QPSK (quadrature phase shift keying) modulation, to prepare the multiplexed signal for transmission over an RF (radio frequency) link such as that provided by satellite to the headend 122. The QPSK signal is then typically received by a satellite receiver at the headend (not shown) and then stored (i.e., buffered) in media content database 112. Selected media content 252 (e.g., a subset of the media content received at headend 122 such as with PPV or VOD) is served by the media content server 105. In alternative arrangements, media content database 112 is not used (i.e., there is no local media content storage) and the media content is only stored remotely from the headend 122 and transmitted to headend 122 typically using a satellite link or fiber optic connection.

A terminal is authorized using an Entitlement Management Message 239 (“EMM”). EMM 239 is sourced from media content ownership database 117. Information in ECM 234, in combination with a valid EMM 239, is used by a DRM system in the terminal to derive a decryption key for decrypting the media content. In accordance with an aspect of the present arrangement, EMM 239 is typically arranged to include usage policies including, for example, how, when, and on which devices the media content may be rendered.

In one illustrative implementation, EMM 239 is sent to the media content server by the conditional access system 202 as part of the multiplexed signal from multiplexer 245. Accordingly, EMM 239 is furnished from content ownership database 117 to multiplexer 245 and is distributed to all the terminals over distribution network 125 (FIG. 1). However, only the target terminal is capable of decrypting the EMM intended for it, thus EMM 239 cannot be intercepted and used by unauthorized terminals. EMM 239 includes usage policies that reflect a subscriber's particular rights to use media content that are associated, for example, with a monthly subscription to a cable television package or individual purchases on an outright purchase or PPV or VOD basis. In another illustrative implementation, EMM 239 is sent directly to the media content server 105 from media content ownership database 117 without being multiplexed and/or modulated by multiplexer/modulator 245 as indicated by the dashed line 255 in FIG. 2. In various alternative arrangements, terminals are identified using an assigned terminal identifier, a device serial number, or a globally unique identifier such as a MAC (media access control) address.

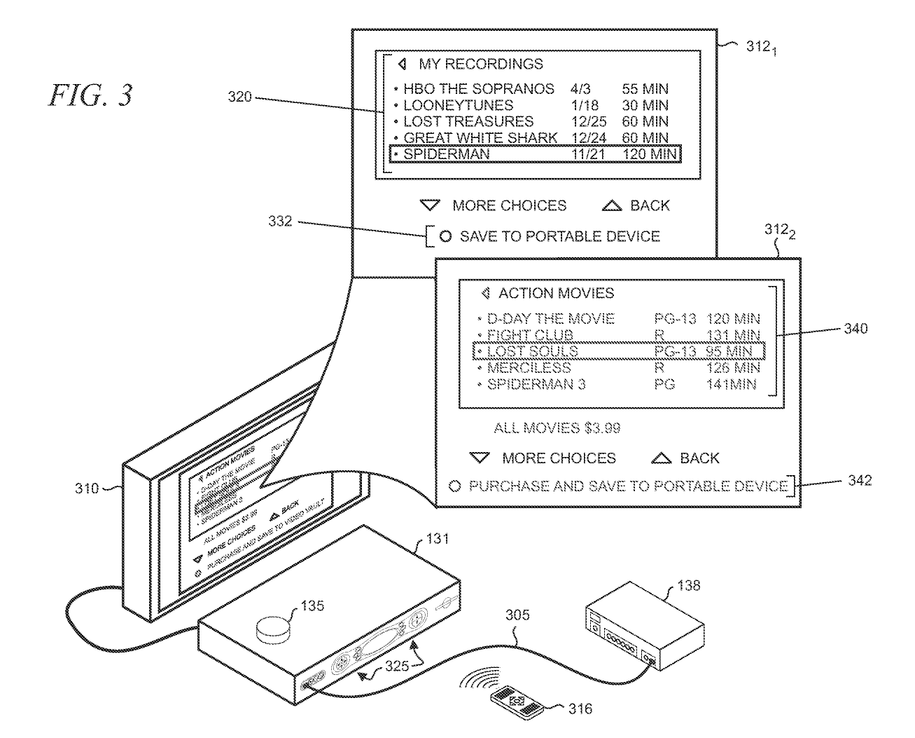

FIG. 3 is a pictorial view of STB 131 and portable media content storage and rendering device 138 that are operatively coupled with a cable 305. Cable 305 provides a connection over which media content is transferable from STB 131 to portable media content storage and rendering device 138 and is selected as conforming with one of a variety of high bandwidth bus protocols including, for example, USB (Universal Serial Bus) USB-2, IEEE-1394 (Institute of Electrical and Electronics Engineers), serial, parallel, SCSI (Small Computer System Interface) and the like. In an alternative embodiment, a wireless communication protocol may be used to supplement or replace the cable 305. Such wireless communication protocols include, for example, IEEE 802.11, Bluetooth or Zigbee.

STB 131 is coupled to a television 310 on which are displayed several illustrative graphical user interface (“GUI”) screen shots 312 that are provided by an application hosted by STB 131. In an illustrative example, the functionality provided by the GUI application is incorporated into existing applications that commonly run on terminal devices. For example, the software routines and methods provided by a standalone GUI application may be desired to be made part of an electronic program guide (“EPG”) application. An EPG is commonly hosted by STBs allowing a user to navigate, select, and discover available media content by time, title, channel, genre, etc., typically by interacting with the EPG using a remote control 316. Alternatively, an application programming interface (“API”) is usable for implementing the GUI screens 312 where the API is accessible by other applications running on a terminal device.

GUI screen shot 312, depicts an illustrative menu 320 showing various programs that a user has recorded onto the DVR 135 that is integrated in STB 131. The user typically scrolls or points in order to select a recorded program using the remote control 316 or controls 325 on the front panel of STB 131. Then, using button 332 the user initiates a process where a copy of the selected recorded program is transferred to the portable media content storage and rendering device 138 from the DVR 135 in STB 131.

GUI screen shot 3122 depicts an illustrative menu 340 showing various programs that are available to a user to be copied to the portable media content storage and rendering device 138. In this illustrative example, the choices shown in menu 340 reflect several in the “action movie” genre that are available on demand for consumption using the portable media content storage and rendering device 138 on a pay basis. The user scrolls or points in order to select a program from the menu using the remote control 316 or controls 325. Using button 342 on menu 340, the user initiates a process where the selected media content from menu 340 is served from media content server 105 (FIG. 1) to STB 131. The selected media content is then transferred to the portable media content storage and rendering device 138 from the STB 131.

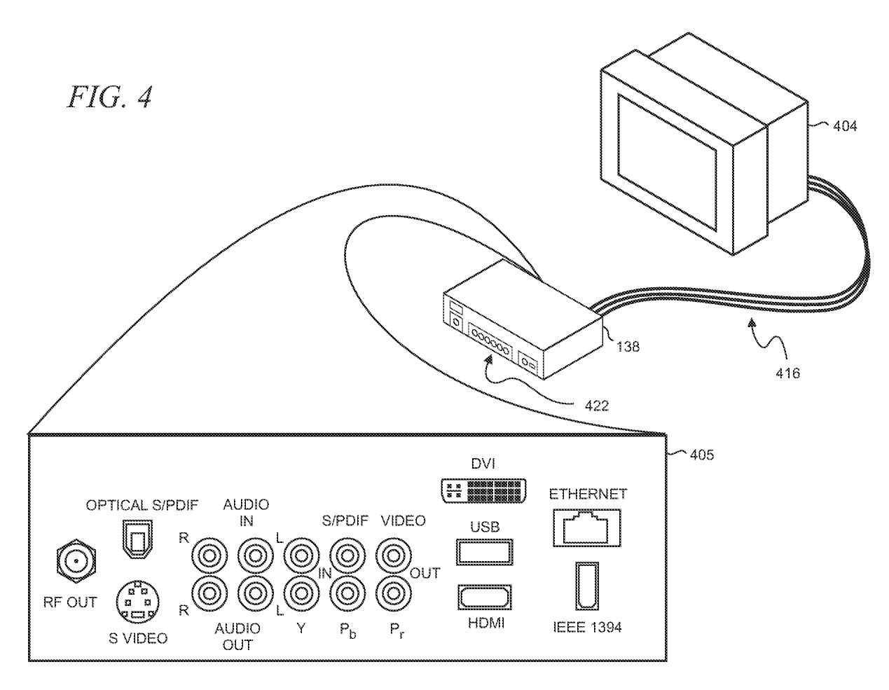

FIG. 4 is a pictorial view of the portable media content storage and rendering device 138 as operatively coupled to a presentation device 404 along with a view of the portable media content storage and rendering device's back panel 405. portable media content storage and rendering device 138 is coupled to presentation device 404 using cables 416 which, in this example, include a single composite video cable and two cables for audio (typically left and right stereo channels). Presentation device 404 includes corresponding inputs for video and left and right audio channels. Presentation device 404 typically comprises a television or monitor in most applications.

The portable media content storage and rendering device 138 includes controls 422 which are arranged, in this illustrative example, on the front panel. Controls 422 are typically used to enable user input and selection to a user interface that is displayable on the coupled presentation device 404 and includes common input devices such as buttons, scrolling, pointing and other similar devices. A remote control (not shown) is also usable to supplement or replace controls 422 in alternative arrangements.

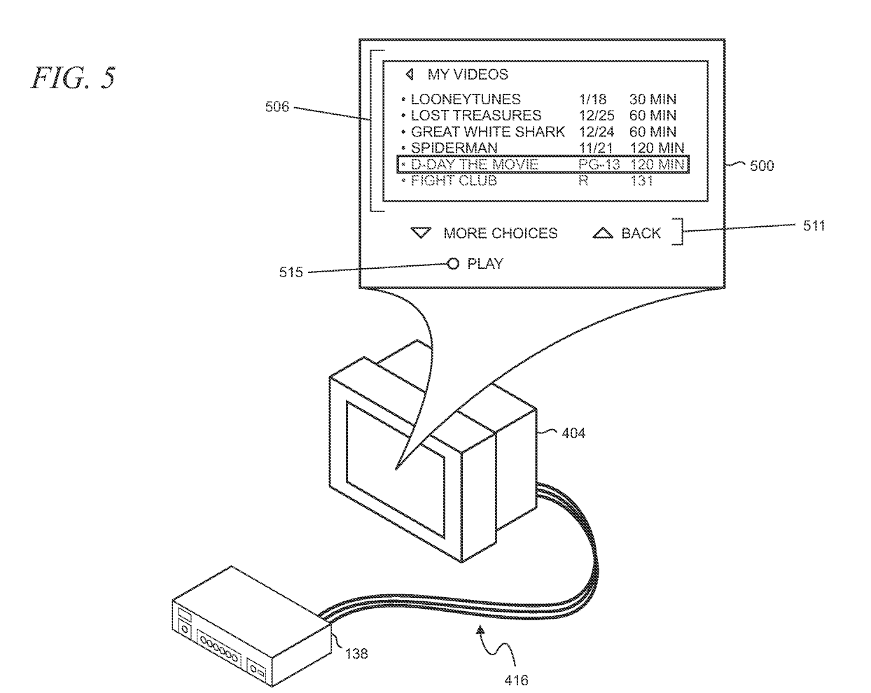

FIG. 5 shows a sample user interface screen 500 that is generated by portable media content storage and rendering device 138 using an EPG-like application. As shown, screen 500 shows a number of choices in a menu 506 of media content that is stored on portable media content storage and rendering device 138 and accessible by the user. Additional media content choices are available on menu 506 using scroll buttons 511. A particular menu choice is played on the presentation device 404 using the play button 515. Screen 500 is representative of a plurality of screens that are generally utilized to create hierarchical menus which facilitate browsing and selection of media content to be played on the coupled presentation device 404. Other menus may be alternatively and/or optionally utilized to enable setting of preferences, adjust video or device settings, and the like. The user typically utilizes controls 422 or a remote control device to facilitate interaction with the displayed screens and menus.

Referring back to FIG. 4, the portable media content storage and rendering device 138 may be arranged with a variety of conventional audio/visual outputs. The back panel 405 of portable media content storage and rendering device 138 shows various illustrative output connections. Typically, a variety of output connector types are included so that portable media content storage and rendering device 138 can be coupled to many different types of presentation devices that may differ in resolution and capabilities. As shown in FIG. 4, the back panel 405 includes an RF connector for coaxial cable, an S video connector, an optical S/PDIF (Sony-Philips Digital Interface Format) connector, component video connectors using RCA-type jacks (referred to as “Y,” “P_{b},” and “Pᵣ” for the luminance and blue and red chroma components in analog and “Y,” “C_{b},” and “Cᵣ” in digital applications), and RGB (red/green/blue) video connector using an RCA-type jack, a regular (i.e., non-optical) S/PDIF connector using an RCA-type jack, audio inputs and outputs using RCA-type jacks, a USB connector, an Ethernet connector, an HDMI (High-Definition Multimedia Interface) connector, a DVI (Digital Visual Interface) connector, an Ethernet connector, and a IEEE-1394 connector.

The different output connectors are intended to enable the portable media content storage and rendering device 138 with the capability to render media content onto a wide variety of coupled presentation devices. Such capability makes the portable media content storage and rendering device 138 presentation device-independent and provides the device with the flexibility to be used in many different situations.

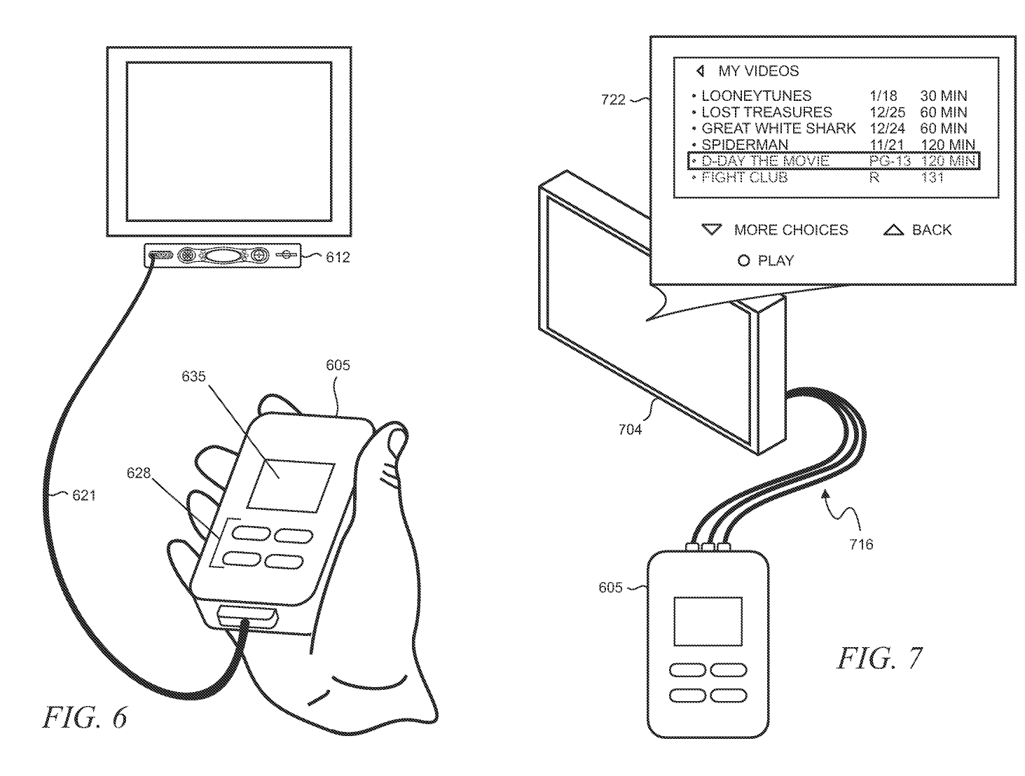

FIG. 6 is a pictorial view of an illustrative alternative small form factor portable media content storage and rendering device 605 as operatively coupled to an STB 612 with a cable 621. Cable 621 provides a connection over which media content is transferable from STB 612 to portable media content storage and rendering device 605 and is selected as conforming with one of a variety of high bandwidth bus protocols including, for example, USB, USB-2, IEEE-1394, serial, parallel, SCSI and the like. In some applications, cable 621 is also used to supply power to the portable media content storage and rendering device 605, or alternatively to recharge an internal battery (not shown) disposed in the device.

Portable media content storage and rendering device 605 is arranged as a small form factor alternative to the larger device 138 shown in FIGS. 1 and 3. Although the specific dimensions selected are design choices made in response to specific requirements, generally portable media content storage and rendering device 605 is sized to be conveniently carried in a user's pocket, or in a pocketbook or backpack, for example. To accommodate its physically smaller size, the portable media content storage and rendering device's internal storage (typically a hard disk) is typically reduced in capacity compared with the larger device 138. In addition, the number and variety of output connectors is also typically reduced.

Portable media content storage and rendering device 605 is configured with controls 628 (e.g., buttons, and scrolling, pointing, and selection devices) that enable a user to navigate through menus in order to browse and select media content for viewing. A display 635 is optionally utilized in some applications and may comprise, for example, an LCD (liquid crystal) display. As with the larger device 138, portable media content storage and rendering device 605 normally uses an EPG-type user interface that is displayed on a coupled presentation device such as a television. However, display 635 may be utilized to provide information to the user such as battery status (when an internal battery is utilized) or fault/trouble shooting codes in the event that the external presentation device is unable to be driven by the portable media content storage and rendering device, for example.

In this particular illustrative example of a small form factor portable media content storage and rendering device, as shown in FIG. 7, a single composite video and two (i.e., stereo) connectors are employed which are disposed at the top of the device and three cables (collectively identified by reference numeral 716) are utilized to couple the device to corresponding input connectors in presentation device 704. A user interface screen 722 is displayed on presentation device 704 that is generated by portable media content storage and rendering device 605 using an EPG-like application. Screen 722 includes similar features and functions as screen 500 in FIG. 5.

Portable media content storage and rendering device 605 is further optionally configured to be physically coupled to an STB, or be removably integrated with the STB. Such optional configuration may be utilized as an alternative to the cable connecting arrangement shown in FIG. 6 or to supplement such arrangement. In some applications of the present portable storage and rendering arrangement, device 605 is normally coupled, or docked, to the STB. When so docked, portable media content storage and rendering device 605 receives media content from the STB from time to time according to program recording or preference settings set by a user. In this way, portable media content storage and rendering device 605 performs similarly to DVRs that are commonly integrated into STBs. For example, a user may wish to record an episodic television program on a recurring basis. Using an EPG hosted by the STB, the user sets the desired program for recording. The program is recorded onto the portable media content storage and rendering device 605 when it is later aired. However, unlike a conventional DVR, the device may be detached from the STB and moved to enable playback of the program at another location.

In other applications, the docking of the portable media content and rendering device 605 to the STB is arranged to enable direct control and read/write access to the device's internally disposed memory (such as a hard disk or solid state memory) by the STB. Such control is implementable, for example, by using the serial-ATA (“SATA” or Serial Advanced Technology Attachment) bus architecture that is often configured for point-to-point connection between devices, including hard disk drives.

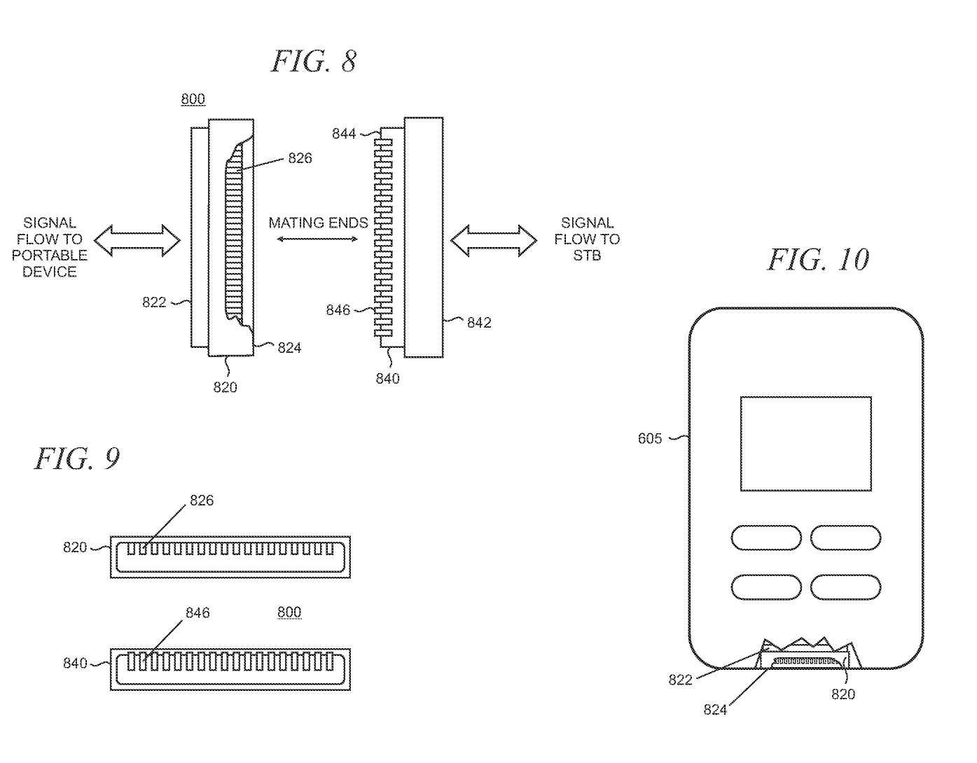

As shown in FIGS. 8 and 9, a connector pair 800 is utilized to enable the portable media content storage and rendering device 605 to be operatively connected to an STB. The connector arrangement 800 comprises two mating connectors. An accessory connector 820 has a circuit end 822 that is arranged to be coupled to electrical circuits in the portable media content storage and rendering device 605, including for example, battery circuitry and/or I/O (input/output) control circuitry. Accessory connector 820 has mating end 824 that is arranged to mate with a corresponding device connector 840. Device connector 840 has a mating end 844 and a circuit end 842 that is arranged to be coupled to electrical circuitry in the STB, including for example an I/O interface in the STB.

The connector arrangement 800 used to connect the portable media content storage and rendering device 605 and STB may be widely varied. Thus, the physical form factor, connector count and configuration of the connector arrangement 800 is typically a matter of design choice for the specific application involved. However, in this illustrative example, connector arrangement 800 includes both power and data contacts. Accessory connector 820 includes a set of contacts 826 which are arranged to engage with corresponding and mating contacts 846 in device connector 840. Accordingly, individual contacts in contact set 826 of accessory connector 820 used for power transmission are operatively coupled to battery circuitry in the portable media content storage and rendering device. Individual contacts in contact set 826 used for data transmission are operatively coupled to the portable media content storage and rendering device's I/O controller circuitry. In addition, then, the power and data contacts in contact set 826 are configured to engage with corresponding contacts in contact set 846 in device connector 840 so as to provide operational or charging power and data transmission between the portable media content storage and rendering device 605 and STB when the connectors 820 and 840 are mateably engaged.

In the illustrative example shown in FIGS. 8 and 9, the contact set 846 in device connector 840 protrude for insertion into the corresponding contacts 826 that are recessed within connector 820 (i.e., a “male” to “female” connection). In some applications, contact set 846 and connector 840 are arranged to snugly fit (i.e., a “friction-fit”) with contact set 826 and connector 820 to hold the connector arrangement 800 together. Alternatively, connectors 820 and 840 may include a locking mechanism for positively locking the connectors together. For example, a latch on a portion of one connector that engages and disengages with a portion of the other connector may be used in some applications.

The arrangement of contacts in connector arrangement 800 may also be widely varied. For example, data transmission functionalities including USB, USB 2, IEEE-1394, serial, SATA, parallel, and other data transmission standards are selected to meet specific requirements. Functionalities may be mixed and combined as well in some applications so that some contacts in the contact sets are dedicated to USB signals while others are dedicated to IEEE-1394 signals. Conventional signals including grounding, charging, powering, signaling protocols, device or accessory identification and similar signals may also be carried across the contacts sets. Accordingly, the number of contacts and their physical configuration will typically vary according to the specific requirements of an application.

FIG. 10 shows a cutaway view of an accessory connector 820 that is disposed within the body of the portable media content storage and rendering device 605. The accessory connector in this example is positioned in the body so that the circuit end 822 is available to circuitry contained internally within the device 605. The mating end 824 is positioned so that it is exposed on an external surface (in this example, the bottom portion of the device 605) to thereby facilitate mateable engagement with a respective corresponding device connector.

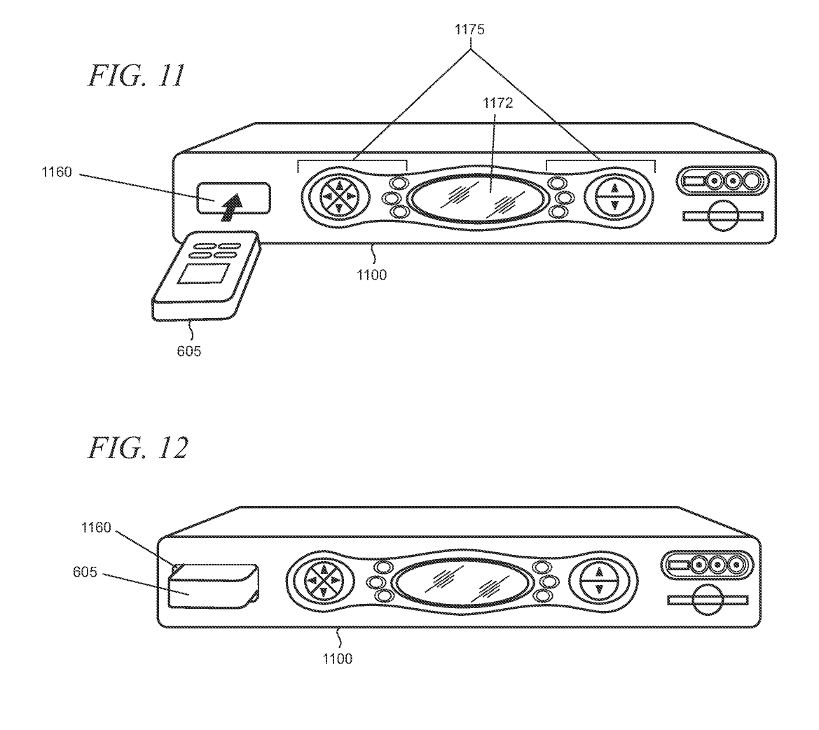

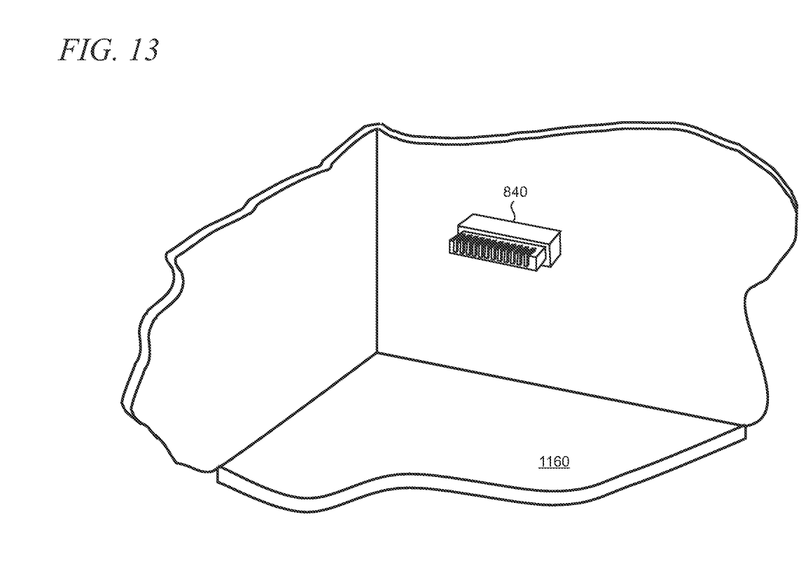

FIG. 11 is a simplified pictorial view of an illustrative STB 1100 having a portable media content storage and rendering device receiving bay 1160 that is substantially disposed within the interior housing of STB 1100 and having an opening in the front surface (i.e., front panel) of the STB 1100. The portable media content storage and rendering device receiving bay 1160 is configured to physically receive the device 605. That is, portable media content storage and rendering device 605 may be inserted into the device receiving bay 1160 to thereby operatively dock with the STB 1100 as shown in FIG. 12. STB 1100 includes a front panel display 1172 and a number of controls 1175, as shown.

While FIG. 11 shows a receiving bay having an opening that is disposed on the front panel of the STB 1100, other configurations for the receiving bay are contemplated as being usable depending on the requirements of a specific application. For example, the receiving bay may be alternatively disposed for access from the top or side of the STB 1100. In addition, the portable media content storage and rendering device 605 and STB 1100 are arrangeable in various type of “piggyback” structure where the device is operatively attached, for example, to a top, front or side panel of the STB using an appropriate connector or set of connectors.

Portable media content storage and rendering device receiving bay 1160 includes the device connector 840 as shown in FIGS. 8 and 9 and described in the accompanying text. FIG. 13 is an enlarged interior perspective view of the portable media content storage and rendering device receiving bay 1160 which is disposed in STB 1100 showing device connector 840 disposed on the rear end portion of the receiving bay 1160 which is spaced apart from and opposes the portable media content storage and rendering device receiving bay opening (not shown). Device connector 840 is typically operatively coupled to various components, for example an I/O interface, in the STB 1100 as described below.

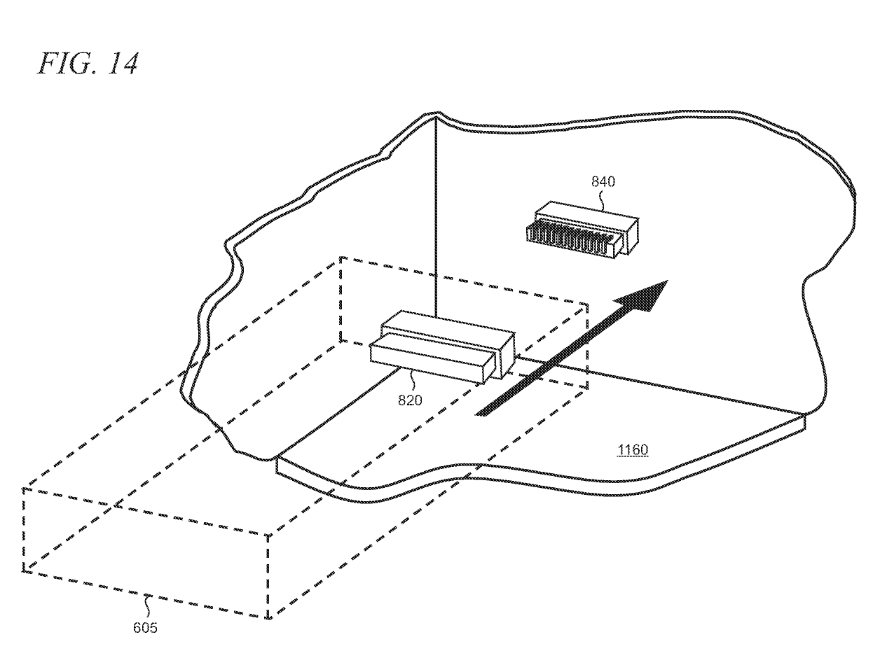

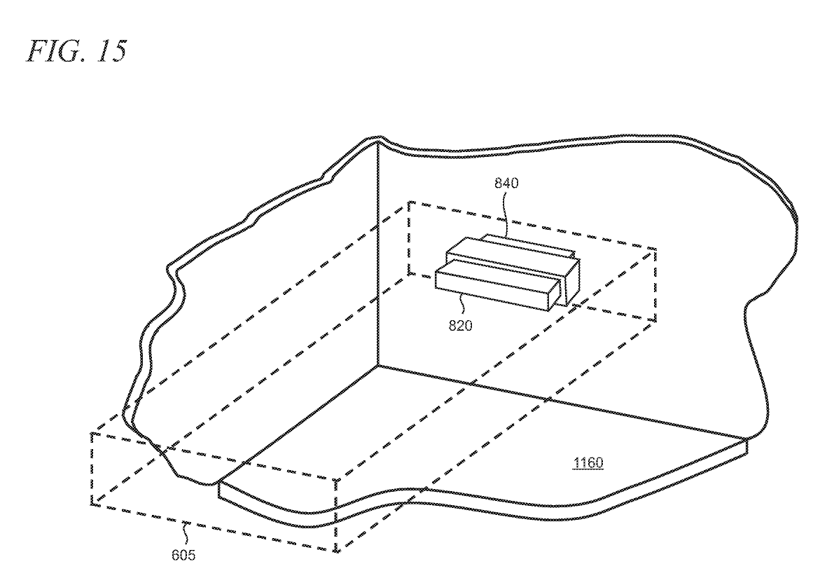

As illustrated in FIG. 14, portable media content storage and rendering device 605 (shown in phantom lines only for sake of clarity in illustration) having the accessory connector 820 disposed along its bottom surface is inserted through the opening in the front panel of the STB 1100. Portable media content storage and rendering device 605 is pushed rearwardly into the device bay receiving bay 1160 until the accessory connector 820 is operatively received and mateably engaged with the device connector 840 as shown in FIG. 15.

Optionally, STB 1100 is arranged with a visual or audible indicator, for example a light or buzzer respectively, to signal to a user that a positive operative connection was made between the portable media content storage and rendering device and STB. Such a signal can be helpful positive feedback to the user that the STB “sees” the device (i.e., recognizes that it is connected to the STB) particularly as the device connector 840 is not always located in a position that is easily visible to the user in every application. In addition to a discrete indicator on the STB 1100, existing visual or audible indicating devices in the STB 1100 are alternatively used, for example the panel display 1172, or an internal speaker if the STB 1100 is so equipped. In other applications, the STB 1100 is arranged to display connection status with a docked portable media content storage and rendering device through a user interface such as EPG displayed on a coupled television. Optionally, the STB 1100 and portable media content storage and rendering device 605 may be arranged so that the device 605 displays a message or icon on its display 635 (FIG. 6) which indicates that a positive docking connection has been accomplished.

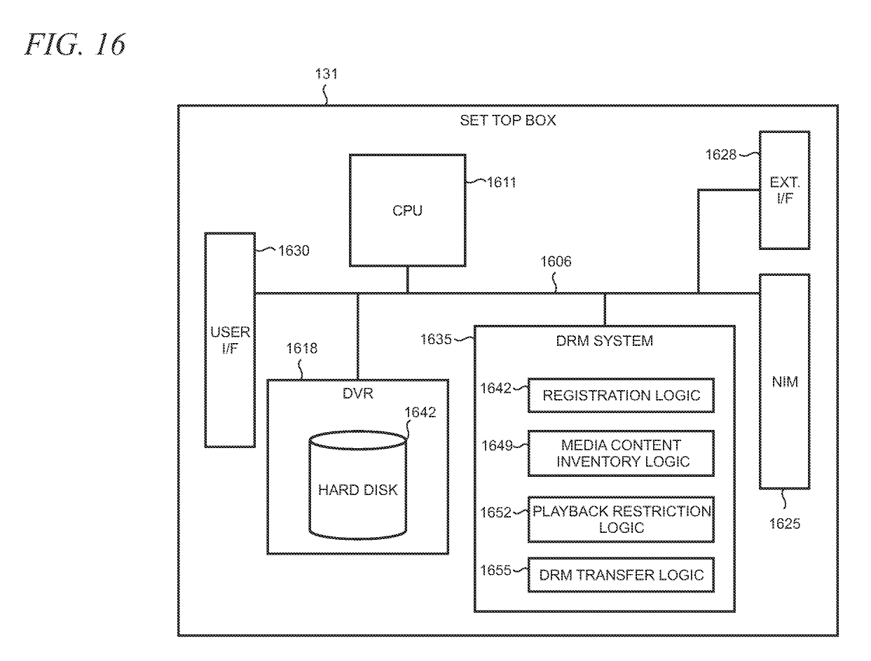

FIG. 16 is a simplified functional block diagram of the illustrative STB 131 shown in FIGS. 1 and 3. A central bus 1606 is utilized to couple a number of components including a central processing unit (“CPU”) 1611, DVR 1618, network interface module (“NIM”) 1625, external device interface 1628, user interface 1630 and DRM system 1635. DVR 1618 includes a memory, such as hard disk 1642 as shown. In some arrangements, the memory is shared with other STB functionalities, for example, for storing STB applications (such as an EPG application) and associated data, code or other instructions that are executed by the CPU 1611 as required to provide a normal STB feature set.

NIM 1625 is utilized as an interface to a media content distribution network, such as HFC network 125 in FIG. 1, to receive media content from a service provider such as an MSO. External device interface 1628 provides connectivity between the STB 131 and external devices including, for example, a portable media content storage and rendering device such as device 138 or device 605 shown respectively in FIGS. 1 and 6. External device interface 1628 is alternatively configurable with a physical interface that uses a cable type connection between the STB 131 and the portable media content storage and rendering device, or uses the connector pair arrangement 800 shown in FIGS. 8 and 9 for a docking-type connection. User interface 1630 is typically utilized with a coupled display (e.g., a television) to provide the EPG-type menus illustratively shown in FIG. 3.

DRM system 1635 includes registration logic 1642, media content inventory logic 1649, playback restriction logic 1652, and DRM transfer logic 1655. It is noted that DRM system 1635 may be implemented as a discretely embodied subsystem in STB 131, or alternatively is arrangeable as a logical structure that is implemented using software instructions stored in memory that are executed by CPU 1611. Another embodiment of DRM system 1635 comprises a combination of physical structure and software. DRM system 1635 may also be incorporated as part of a conditional access system (not shown) that may be included in STB 131 in some applications.

Registration logic 1642 enables the STB 131 to register with a media content service provider. As noted above in the text accompanying FIG. 2, such registration is used in most applications, and in accordance with the present portable storage device arrangement, to authorize STB 131 to receive media content from the service provider, and copy the received media content to an operatively coupled portable media content storage and rendering device.

Media content inventory logic 1649 is arranged to track the media content that is stored in STB 131 (i.e., on disk 1642). Media content inventory logic 1649 interoperates with a similar functionality provided on a coupled portable media content storage and rendering device to determine how media content is distributed across the devices (i.e., whether a particular piece of media content is stored on the STB 131 or portable media content storage and rendering device 138, for example). Such determination may be used in cases where usage rules, policies or restrictions (collectively referred to as DRM license restrictions) are applicable to a particular piece of media content. While not all media content is subject to DRM license restrictions in all settings, many examples of media content may be expected to be covered by some form of DRM which governs how that example of media content may be used or consumed. DRM schemes may be applied to media content consumed on a subscription basis, media content from PPV or VOD sources, and also to outright purchased media content in some cases.

Playback restriction logic 1652 is arranged to restrict the STB 131 from playing media content that is stored on a coupled portable media content storage and rendering device. This restriction may be used when the media content is subject to a DRM license restriction which imposes a limitation on playback devices. For example, a service provider or copyright owner may impose a playback limitation on a movie so that only a single registered device may play the movie at a time. In such a case, playback restriction logic 1652 prevents playback of the movie from the DVR 1618 when the movie has also been copied to a portable media content storage and rendering device. If the movie is subsequently deleted from the device, playback restriction logic 1652 enables the copy on the DVR 1618 to be rendered by the STB 131 onto a presentation device such as a television (note that the various components needed to decode and render media content are not shown in FIG. 16).

DRM transfer logic 1655 operates to transfer to the portable media content storage and rendering device any DRM licenses that may be applicable to a given piece of media content when that media content is copied to the device. DRM transfer logic 1655 thus ensures that the DRM scheme accompanying the media content is preserved intact when the media content is rendered by the portable media content storage and rendering device. For example, a PPV movie may be subject to a limitation on playback to a defined time window (e.g., a viewer may watch the PPV movie an unlimited number of times in a 48 hour period), or be limited to a set number of viewings (e.g., the viewer may watch the PPV movie in its entirety twice with no time limit). DRM transfer logic 1655 provides that the DRM scheme applicable to the PPV movie is consistently maintained across both the STB 131 and portable media content storage and rendering device in a manner that is transparent to the user.

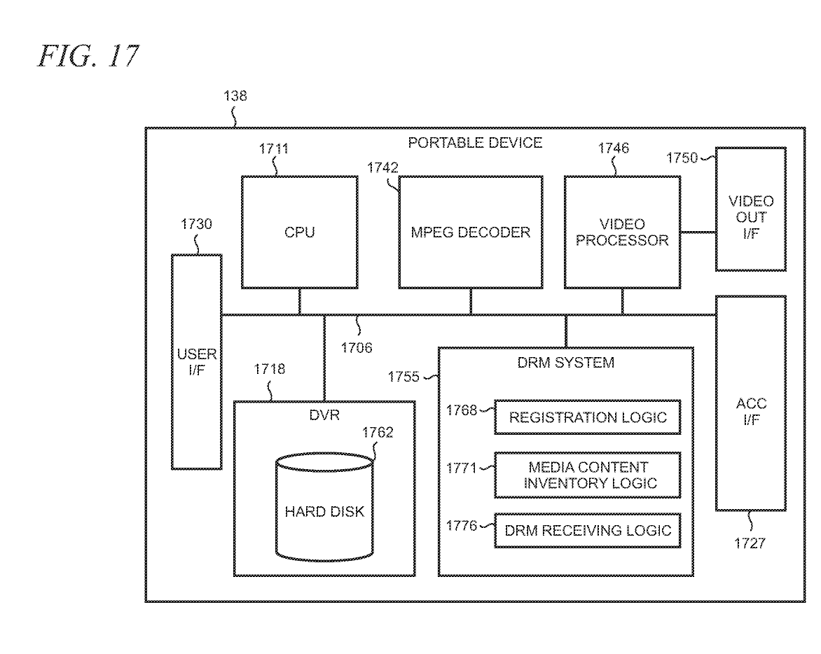

FIG. 17 is a simplified functional block diagram of the illustrative portable media content storage and rendering device 138 shown in FIGS. 1, 3, 4 and 5. Although devices 138 and 605 (FIG. 6) differ in form factor and features, the functions shown in FIG. 17 and described below are applicable to both devices except as otherwise noted.

A central bus 1706 is utilized to couple a number of components including a CPU 1711, DVR 1718, accessory interface 1727, user interface 1730, MPEG decoder 1742, video processor 1746, video output interface 1750 and DRM system 1755. DVR 1718 includes a memory, such as hard disk 1762 that may be shared to support various portable media content storage and rendering device functionalities. For example, applications, instructions, and other code that are executed by CPU 1711 are storable in such memory. Other suitable memory types include solid state memory including random access memory (“RAM”) or Flash RAM type memory structures.

Accessory interface 1727 provides connectivity between the portable media content storage and rendering device 138 and a STB (e.g., STB 131 in FIG. 1) in order to receive media content from the STB. Accessory interface 1727 is alternatively configurable with a physical interface that uses a cable type connection between the portable media content storage and rendering device 138 and the STB, or uses the connector pair arrangement 800 (FIGS. 8 and 9) for a docking-type connection. In addition, accessory interface 1727 may comprise a wireless communication interface including, for example, an interface conforming with one of IEEE 802.11, Bluetooth or Zigbee. User interface 1730 is typically utilized with a coupled display (e.g., a television) to provide the EPG-type menus illustratively shown in FIGS. 5 and 7.

In this illustrative example, MPEG decoder 1742 decodes and decrypts the encoded and encrypted media content received over the accessory interface 1727. As described above in the text accompanying FIG. 2, media content is typically multiplexed with an embedded ECM which is used in combination with an EMM to derive the required key to decrypt the media content. MPEG decoder 1742 is alternatively arranged to perform the required decryption by itself or in combination with a conditional access system that is disposed in the portable media content storage and rendering device 138 (not shown). In other arrangements, the decryption is handled by a discrete subsystem that is implemented in hardware, software, or a combination of hardware and software.

Video processor 1746 processes the decoded MPEG stream to thereby render it on an external presentation device, such as a television or monitor, that is coupled to the video output interface 1750. In some applications of the present portable storage device, the video processor 1746 and MPEG decoder are integrated into a single device. Video processor 1746 is typically arranged to provide an output video signal that is alternatively transmittable using a variety of different resolutions, formats and protocols so as to enable a large degree of presentation device-independence. In this illustrative example, Video processor 1746 provides video output using one or more of the connectors shown in FIG. 4 and described in the accompanying text. In applications where the portable media content storage and rendering device is arranged using the small form factor (e.g., device 605 in FIG. 6), it may be desirable to provide fewer output connection alternatives to save space. In such a case, video processor 1746 may generally be implemented with less complexity (i.e., less video memory, slower onboard processor etc.). However, it is emphasized that the video processor 1746 will generally be configured as necessary to strike a particular balance between feature set and complexity as dictated by specific circumstances.

DRM system 1755 includes registration logic 1768, media content inventory logic 1771 and DRM receiving logic 1776. It is noted that DRM system 1755 may be implemented as a discretely embodied subsystem in portable media content storage and rendering device 138, or alternatively is arrangeable as a logical structure that is implemented using software instructions stored in memory that are executed by CPU 1711. Another embodiment of DRM system 1755 comprises a combination of physical structure and software. DRM system 1755 may also be incorporated as part of a conditional access system that may be included in portable media content storage and rendering device 138.

Registration logic 1768 is similar to that shown in FIG. 16 in that it is arranged for enabling the portable media content storage and rendering device 138 to register with a media content service provider to thereby authorize the device 138 to receive media content from the service provider via a STB (e.g., STB 131). As described above, only registered devices are typically enabled to render media content.

Media content inventory logic 1771 is arranged to track the media content stored on the portable media content storage and rendering device 138 (i.e., on disk 1762). Media content inventory logic 1771 typically interoperates with the corresponding functionality supported by STB 131 to determine how media content is distributed between the STB 131 and portable media content storage and rendering device 138. Thus, as media content is received by STB 131, copied to device 138, and consumed and/or deleted on either device, an inventory of media content stored on each device is dynamically maintained by the media inventory logic component of the respective DRM systems.

DRM receiving logic 1776 DRM operates to receive any DRM licenses that may be applicable to a given piece of media content when that media content is copied to the portable media content storage and rendering device 138 from the STB 131. DRM receiving logic 1776 thus ensures that the DRM scheme accompanying the media content is preserved intact when the media content is rendered by device 138.

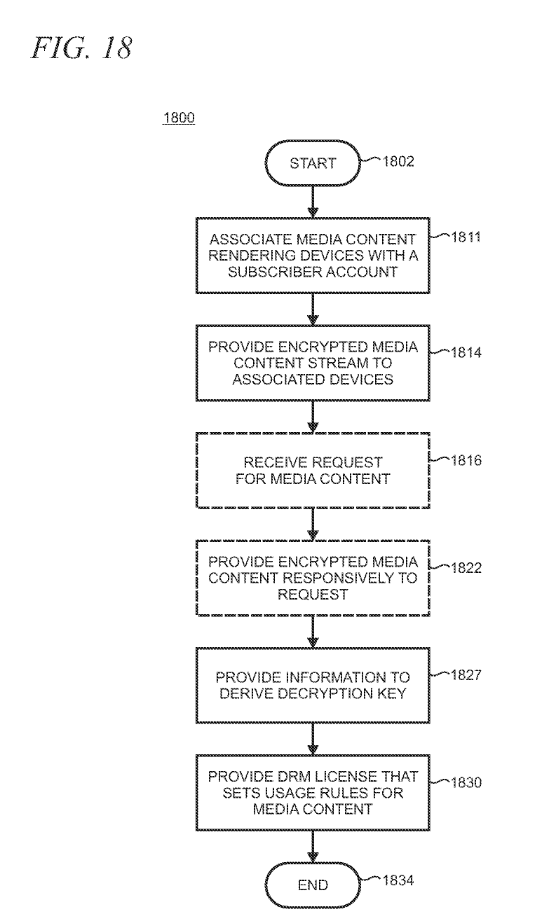

FIG. 18 is a flowchart of an illustrative method 1800 for providing a media content distribution service. The method starts at block 1802. At block 1811, a plurality of content rendering devices are associated with a subscriber's account. For example, a typical subscriber to a multimedia service provided by an MSO may have several STBs in a home plus a portable media content storage and rendering device. Each of these devices is registered with the service so that media content may rendered and shared among them. In one illustrative embodiment, the association among the plurality of content rendering devices is maintained in business system database such as media content ownership database 117 in FIG. 1.

At block 1814, a media content stream is provided to the associated devices. Typically, this media content stream is encrypted as described above in the text accompanying FIG. 2, for example as part of a cable television subscription service in which multiple channels are multiplexed into a MPEG-2-compliant DTV stream from a system such as headend 122. At block 1816, a request for media content is received by the service. Generally, such request is generated by a user at one of the content rendering devices such as STB, for example, to order a specific piece of media content such as a PPV or VOD movie. Responsively to the request, media content is transmitted over a network such HFC network 125 in FIG. 1, as indicated by block 1822 in FIG. 18. As PPV and VOD services are not necessarily used by every service subscriber, the steps shown in blocks 1816 and 1822 should be considered as optional, as indicated by the dashed lines in FIG. 18.

At block 1827, information is provided by the service to the associated authorized devices so that they may derive the required decryption key to decrypt the encrypted media content stream. As described above in the text accompanying FIG. 2, in one illustrative embodiment of the present arrangement, the media content stream is encoded with an ECM. A separately transmitted EMM is used in combination with the ECM to derive the decryption key.

At block 1830, a DRM license that is associated with some media content is provided by the service. The DRM license sets usage rules, policies or restriction that are applicable to certain media content. In some applications of the present arrangement, the DRM license restrictions in one form or another are applied to all media content. For example, some media content may be limited in terms of number of playback devices that may be used to render the content. Other media content may be limited to time window for viewing or a limited total play count. In other applications, the DRM license restrictions are applied to selected media content only, for example, PPV media content.

The DRM license provided by the service is utilized by a STB and associated portable media content storage and rendering device, as described in the text accompanying FIGS. 16 and 17 to ensure that the DRM scheme applicable to the media content is consistently maintained across both the STB and portable media content storage and rendering device in a manner that is transparent to the user. Illustrative method 1800 ends at block 1834.

Each of the processes shown in the figures and described above may be implemented in a general, multi-purpose or single purpose processor. Such a processor will execute instructions, either at the assembly, compiled or machine-level, to perform that process. Those instructions can be written by one of ordinary skill in the art following the description contained herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

What is claimed is:

1. A media content storage device, comprising:
an input interface arranged for receiving media content having DRM protection from a terminal with access to a media content provider over a delivery network;
a memory coupled to the input interface for storing the media content;
a DRM system arranged to control rendering of the stored media content in compliance with the DRM protection; and
a video processor arranged for rendering the stored media content to an external presentation device.

2. The media content storage device of claim 1 in which the DRM system is further arranged to enable the receiving of the media content when the media content storage device has a registration with the media content provider.

3. The media content storage device of claim 2 in which the registration is based on a unique identification associated with the media content storage device, the unique identification being selected from one of serial number, ID number, or MAC address.

4. The media content storage device of claim 1 in which the terminal is a set top box.

5. The media content storage device of claim 1 in which the delivery network is one of satellite network, telephone network, Internet network, or CATV network.

6. The media content storage device of claim 1 further including a display interface for outputting the stored media content for presentation on a display.

7. The media content storage device of claim 6 in which the display interface is arranged to selectively generate one of a plurality of output formats, the output formats varying in resolution, aspect ratio, or frame rate.

8. The media content storage device of claim 1 further including an MPEG-2-compliant decoder for decoding the stored media content.

9. The media content storage device of claim 1 further including a docking interface that is arranged to mateably engage with a dock disposed in the terminal so as to enable the receiving when the media content storage device is docked with the terminal.

10. The media content storage device of claim 1 in which the input is coupled to the terminal using a wired or wireless connection, the wired connection being selected from one of USB cable, IEEE-1394 cable, serial cable, SATA cable, or parallel cable, and the wireless connection being selected from one of IEEE 802.11, Bluetooth or Zigbee.

11. The media content storage device of claim 1 further including a user interface for receiving user input and displaying information, the user interface being selected from a control disposed on the media content storage device, a display device, a remote control, or combinations thereof.

12. The media content storage device of claim 1 in which the memory is arranged from one of hard disk, RAM, or flash memory.

13. A method for providing a media content delivery service, the method comprising the steps of:
associating a plurality of content rendering devices with a subscriber account, a first device in the plurality comprising a portable media storage device and a second device in the plurality comprising a set top terminal that is arranged to interoperate with the portable media storage device;
providing media content to the associated content rendering devices; and
providing a DRM license, the DRM license arranged for setting usage policies for the media content including (a) limiting rendering of the media content to only the associated content rendering devices, and (b) allowing copying of the media content among the associated content rendering devices.

14. The method of claim 13 further including encrypting the media content using a key.

15. The method of claim 14 further including distributing a plurality of messages to the associated one or more content rendering devices, the messages being usable to derive the key for the decrypting the encrypted media content.

16. The method of claim 15 in which the plurality of messages include an Entitlement Control Message (ECM) and an Entitlement Management Message (EMM).

17. The method of claim 16 in which the ECM is multiplexed with the encrypted media content.

18. The method of claim 13 in which the media content is transmitted from one of a PPV server or a VOD server.

19. The method of claim 14 in which encrypting conforms with one of DigiCipher, DigiCipher II, or MediaCipher.

20. A set top box, comprising:
an input interface arranged to receive media content having DRM protection from a media content provider over a delivery network;
a DVR coupled to the input for recording the media content; and
a DRM system arranged for (a) determining whether a portable media storage device is authorized to receive a copy of the media content (b) transferring the DRM protection to the copy of the media content so that the copied media content is renderable by the portable media storage device in compliance with the DRM protection, and (c) restricting rendering of the recorded media content on the DVR by the set top box when the media content has been copied to the portable storage device.

21. The set top box of claim 20 further including a memory containing instructions for implementing an EPG application arranged for providing a user interface for selecting media content to be copied from the set top box to the portable media storage device.

22. The set top box of claim 20 further including a portable media storage device receiving bay disposed in a housing of the set top box, the receiving bay including a device connector and a receiving bay opening, the receiving bay opening providing access to the device connector, the device connector being configured for removable engagement with the accessory connector, the device connector and accessory connector providing a communication interface between the set top box and the portable media storage device that allows data transmission therethrough when operatively coupled.

23. The set top box of claim 22 in which the communication interface includes a plurality of different interfaces, the interfaces being selected from PS/2, serial, SATA, parallel, network, USB or IEEE-1394 interfaces.
